(19) United States
(12) Patent Application Publication
(10) Pub. No.: US 2024/0312142 A1
(43) Pub. Date: Sep. 19, 2024

(54) MIXED-REALITY SOCIAL NETWORK AVATAR VIA CONGRUENT LEARNING

(71) Applicant: INTERNATIONAL BUSINESS MACHINES CORPORATION, ARMONK, NY (US)

(72) Inventors: Zachary A. Silverstein, Georgetown, TX (US); Kelley Anders, East New Market, MD (US); SIDDHARTH K. SARAYA, Raniganj (IN); Jonathan D. Dunne, Dungarvan (IE)

(21) Appl. No.: 18/182,452

(22) Filed: Mar. 13, 2023

(51) Int. Cl. G06T 19/00; G06T 13/40

(52) U.S. Cl. CPC G06T 19/006; G06T 13/40

(57) ABSTRACT

According to one embodiment, a method, computer system, and computer program product for adjusting an audible area of an avatar's voice is provided. The present invention may include detecting an available state of a user participating in a mixed-reality environment; generating behavior for a user avatar representing the user in the mixed-reality environment; controlling the user avatar to perform the generated behavior; monitoring the mixed-reality environment to identify if a participant is interacting with the user avatar; and responsive to detecting an interaction between a participant and the user avatar, notifying the user of the detected interaction.

### BACKGROUND

The present invention relates, generally, to the field of computing, and more particularly to mixed reality. Mixed reality is a field concerned with merging real and virtual worlds such that physical and digital objects co-exist and interact in real time. Mixed reality does not exclusively take place in either the physical or virtual worlds but is a hybrid of reality and virtual reality; as such, mixed reality describes everything in the reality-virtuality continuum except for the two extremes, namely purely physical environments and purely virtual environments. Accordingly, mixed reality includes augmented virtuality (AV), augmented reality (AR) and virtual reality (VR). Mixed reality has found practical applications in such areas as remote working, construction, gaming, military, academic and commercial training, and in social networking.

Mixed-reality systems use software to generate images, sounds, haptic feedback, and other sensations to augment a real-world environment. While the creation of this augmented environment can be achieved with mobile devices such as cell phones or tablets, more specialized equipment is also used, typically in the form of glasses or headsets where computer generated elements are overlaid onto a view of the real world by being projected or mapped onto a lens in front of a user's eyes. With the help of computer augmentation, information about the surrounding world of the user, as well as other digital elements overlaid onto the world, become interactive and digitally manipulable.

One rising application of mixed reality is that of the mixed-reality social networks. In such applications, multiple individuals may be placed into a virtual reality environment, where they are each represented by virtual avatars, and may be able to see and freely interact with the avatars of other participants. The goal of the mixed reality social network is to virtually recreate a real-world social gathering in a mixed-reality environment, to allow individuals who are may not be or cannot feasibly be physically present with each other to interact and socialize in a fashion recreating in-person physical presence, within a mixed-reality space that can be accessed from their own home simply by donning a mixed-reality device.

### SUMMARY

According to one embodiment, a method, computer system, and computer program product for adjusting an audible area of an avatar's voice is provided. The present invention may include detecting an available state of a user participating in a mixed-reality environment; generating behavior for a user avatar representing the user in the mixed-reality environment; controlling the user avatar to perform the generated behavior; monitoring the mixed-reality environment to identify if a participant is interacting with the user avatar; responsive to detecting an interaction between a participant and the user avatar, notifying the user of the detected interaction.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a congruent learning process according to at least one embodiment; and

FIG. 3 is an operational flowchart 300 illustrating a generating step of a congruent learning process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to mixed reality. The following described exemplary embodiments provide a system, method, and program product to, among other things, detect an available state of a user, generate behavior for an avatar of the user in a mixed-reality environment, and transmit interactions or notifications of interactions to the user for the duration of the available state.

As described above, mixed-reality social networks may comprise multiple individuals placed into a virtual reality environment, where they are each represented by virtual avatars, and may be able to see and freely interact with the avatars of other participants. However, an inevitable issue with any mixed-reality experience is the inherent need for a human user to cease participating in the mixed-reality environment for some amount of time to attend to tasks in their physical environment; mixed-reality environments are distinct among digital media formats in that they require the user to move and interact with the virtual environment in the same way that the user would interact with a physical environment, such as by moving their head, walking, holding and manipulating objects, standing for prolonged periods, et cetera, but all the while holding or wearing visual displays before their eyes and following the user's head movements, wearing speakers that provide a link to audio in the mixed-reality environment, holding controllers, in some cases being restricted to movement within a discretely bounded area covered by sensors and/or while tethered to a power source and/or computer, et cetera. As a result, there is a physical attrition and sensory isolation inherent to participating in a mixed-reality session that motivates periodic brief disconnection over the course of a mixed-reality session that does not rise to formal termination and conclusion of the mixed-reality session, for example to fetch water or food, to interact with others in the physical environment, or even simply to rest. In such circumstances, the user may take off the mixed-reality device or devices, leave the mixed-reality devices on but moves beyond the bounds of the area where his or her movements are tracked by the mixed-reality device, leave a mixed-reality headset and/or audio device on but put down controllers or other peripherals, et cetera.

In such situations, the avatar representing the user may display uncanny behavior, as the avatar's movement, and/or movement of its limbs, head, et cetera, may be mapped to different mixed-reality devices such as headsets, handheld controllers, wearable sensors, et cetera; such devices, when held or worn in the intended manner by the user, provide positional and movement data to the mixed-reality system that correspond to the user's natural movement in the physical environment, allowing the avatar to emulate the motions of the user. However, when a user abandons the mixed reality environment to perform a task, the user may discard the mixed-reality devices, draw them apart from each other, move them away from sensors that track them, or otherwise interrupt or distort the data provided to the mixed-reality system by the mixed-reality devices; the avatar may then, in virtually representing the motion of the discarded or out-of-position mixed reality devices, twist into unnatural shapes or move in an unnatural fashion. Such strange movement damages the immersion of the mixed-reality experience for other participants.

There have been some attempts to address this issue by detecting anomalous positional data from the mixed-reality devices, or positional data that has remained static for a threshold duration, implying that the user is no longer present, and may thereby determine that the user is in an inactive state. Such solutions might then decouple the avatar from the mixed-reality devices' movements, locking the avatar into a fixed position or default animation, and await a signal or other trigger from the mixed-reality device or devices to toggle back to an active state and resume mapping the user's physical movements to the avatar's virtual movements. However, this binary determination between active and passive states may be insufficient; in some situations, a user may not be actively moving and engaging with the mixed-reality environment through the user's avatar, and may therefore appear to be in a passive state, but may in fact be available and willing to resume an active state and interact in the mixed-reality environment. For example, the user may leave the mixed-reality experience to retrieve a glass of water, or to simply take a quick break from the mixed-reality environment, but may be willing and able to return to the mixed-reality environment at a moment's notice in response to an interaction in a mixed-reality environment, such as a friend logging in or moving their avatar close to the user's avatar, or a participant communicating with the user's avatar through speech or text or gestures. However, when the user's avatar is in a passive state, for example standing still and gazing straight ahead, or performing a single looping idle animation or a number of sequential idle animations selected from a library of default animations, other participants in the mixed-reality environment may recognize the passive state and be dissuaded from interacting with the user's avatar. Alternatively, participants may interact with the user's avatar, but the user is not aware because, for example, the user may not be wearing the mixed-reality device. In some situations, the user may still be wearing a headset connected to the audio in the mixed-reality environment, and therefore may hear and/or speak to participants in the mixed-reality environment, but is not wearing or looking at the mixed-reality display and therefore cannot see avatars of other participants, nor their gestures or motions or overlaid text.

As such, it may be desirable to implement a system which recognizes a third state in addition to the passive and active state of a user of a mixed-reality experience, which represents a user state where the user is not actively participating in the mixed-reality experience, but may be available to resume an active state and/or may wish to be apprised of interactions occurring between the user's avatar and avatars of one or more other participants. Such a system may, for example, represent such a state by dynamically generating behavior for the avatar that allows the avatar to behave naturally within the mixed reality environment, appearing animated and interacting naturally with the mixed-reality environment despite receiving no motion data or anomalous motion data from the user, and thereby encouraging interaction with other participants. Additionally, during such state a system may monitor for interactions occurring between the user's avatar and other participants, and may notify the user of such interactions and/or invite the user to a voice channel with other participants through a device outside of the mixed-reality system, such the user's mobile device, to preserve congruous interaction between the user's avatar and the participant. Such a system would allow the user to leave the mixed-reality environment as needed without missing any social interactions that might otherwise have been discouraged by the avatar's behavior or gone unperceived in the user's absence, thereby overcoming the practical and technical barriers to social interaction inherent to the mixed-reality social network as a result of physical attrition and sensory isolation, and in turn improving the user's experience. Additionally, such a system may further reduce instances of unnatural or uncanny behavior from avatars, improving the immersion of a mixed-reality social network.

Aspects of the invention may comprise a system and method of identifying an available state of a user based on physical and virtual user activity, generate in-universe behavior for an avatar representing the user within a mixed-reality environment based on virtual elements within the mixed-reality environment, and implement the generated behavior in the avatar.

In some embodiments of the invention, the system may further monitor for interactions between an avatar of the user and avatars of one or more participants within the mixed reality environment and transmit notifications of detected interactions to the user. In some embodiments, the system may transmit notifications to a system or device outside of the mixed-reality system, such as the user's mobile device. In some embodiments of the invention, the system may initiate a voice call between a participant and the user, for example by calling the user's mobile device.

In one or more embodiments of the invention, the mixed-reality environment may be a hybrid environment comprising both physical and virtual elements. The mixed reality environment may comprise a hybrid physical-virtual world which one or more users may enter, see, move around in, interact with, et cetera through the medium of a mixed-reality device. The mixed reality environment may include augmented reality environments wherein generated images, sounds, haptic feedback, and other sensations are integrated into a real-world environment to create a hybrid augmented reality environment, comprising both virtual and real-world elements. The mixed reality environment may include virtual reality environments which fully replace the physical environment with virtual elements, such that a user experiencing a virtual reality environment cannot see any objects or elements of the physical world; however, the virtual reality environments are anchored to real-world locations, such that the movement of users, virtual objects, virtual environmental effects and elements all occur relative to corresponding locations in the physical environment. All users in a single mixed-reality environment may be able to see and/or interact with the same virtual objects and virtual elements, and may interact with virtual representations, or avatars, of each other.

In some embodiments of the invention, the mixed reality device may be any device or combination of devices enabled to record real-world information that the mixed reality program may overlay with computer-generated perceptual elements to create the mixed-reality environment; the mixed reality device may further record the actions, position, movements, et cetera of the user, to track the user's movement within and interactions with the mixed reality environment. The mixed reality device may display the mixed reality environment to the user. The mixed reality device or devices may be equipped with or comprise a number of sensors such as a camera, microphone, accelerometer, et cetera, and/or may be equipped with or comprise a number of user interface devices such as displays, touchscreens, speakers, et cetera. In some embodiments, the mixed reality devices may comprise a headset that is worn by the user, a handheld controller, one or more infrared sensors disposed within the environment, et cetera.

In one or more embodiments of the invention, the user may be an individual interacting with the mixed-reality environment through the use of a mixed-reality device. The participants may be non-user individuals who are likewise interacting with the mixed-reality environment through the use of a mixed-reality device.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to detect an available state of a user, generate behavior for an avatar of the user in a mixed-reality environment, and transmit interactions or notifications of interactions to the user for the duration of the available state.

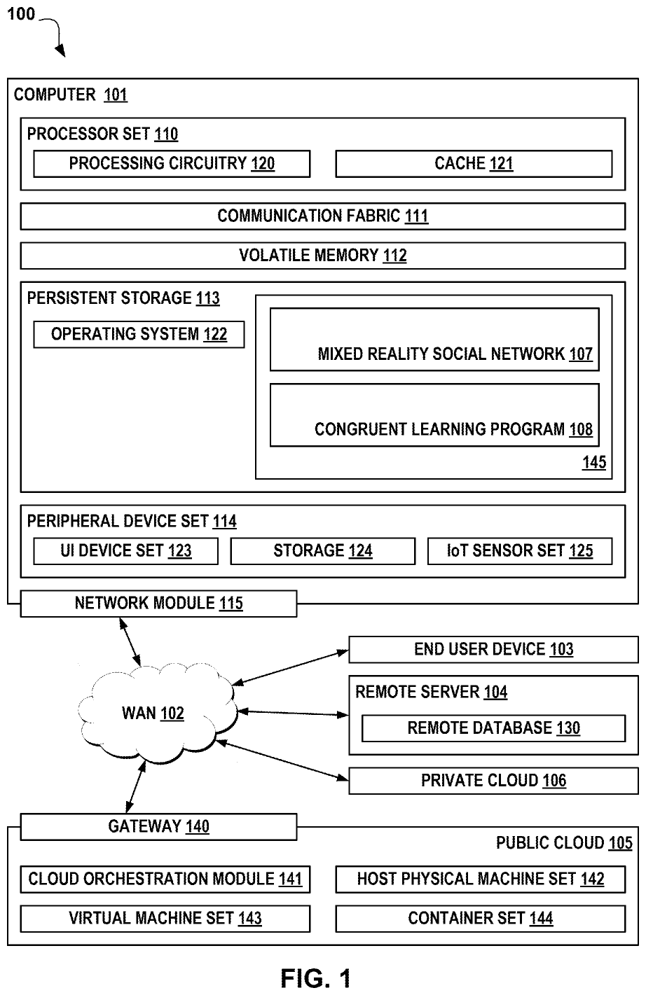

Referring now to FIG. 1, computing environment 100 contains an example of an environment for the execution of at least some of the computer code involved in performing the inventive methods, such as code block 145, which may comprise mixed-reality social network 107 and congruent learning program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as mixed-reality headsets, goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, sensors may include gyroscopes, cameras, LIDAR, accelerometers, et cetera for head tracking, motion tracking, tilt detection, and other such functions. The sensors may further include microphones. The sensors may be integrated into one or more mixed-reality devices, which may be handheld, wrist-mounted, head-mounted, et cetera. The one or more of the mixed-reality devices may further comprise digital displays, speakers, et cetera.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the mixed-reality social network 107 may be a program capable of creating and maintaining a mixed-reality environment and enabling individuals to connect to and interact with the mixed-reality environment and each other through the use of avatars. Avatars may be three-dimensional virtual characters that represent an individual. The individual to which the avatar corresponds may be bound to the single perspective and location of the avatar but may control the movements and actions of the avatar to navigate and interact with the mixed-reality environment and participant avatars, objects, or other virtual elements within the mixed-reality environment. The individual to which the avatar corresponds may additionally control the appearance, dimensions, and other characteristics of the avatar. In some embodiments, portions of the avatar, such as the hands and/or head, may be directly mapped to their physical counterparts on the individual to whom the avatar corresponds, such that as the individual moves a mapped body part, the avatar executes the same motion with the matching virtual body part. The mixed-reality social network 107 enables individuals such as the user and other participants to interact through audible speech. The mixed-reality social network 107 may comprise, be integrated with, or otherwise be configured to interoperate with congruent learning program 108. However, while embodiments may be described herein by reference to a mixed-reality social network 107, one of ordinary skill of the art would understand that the mixed-reality social network 107 could be replaced with any software program creating and maintaining a mixed-reality environment capable of hosting two or more individuals and enabling hosted individuals to see and interact with each other.

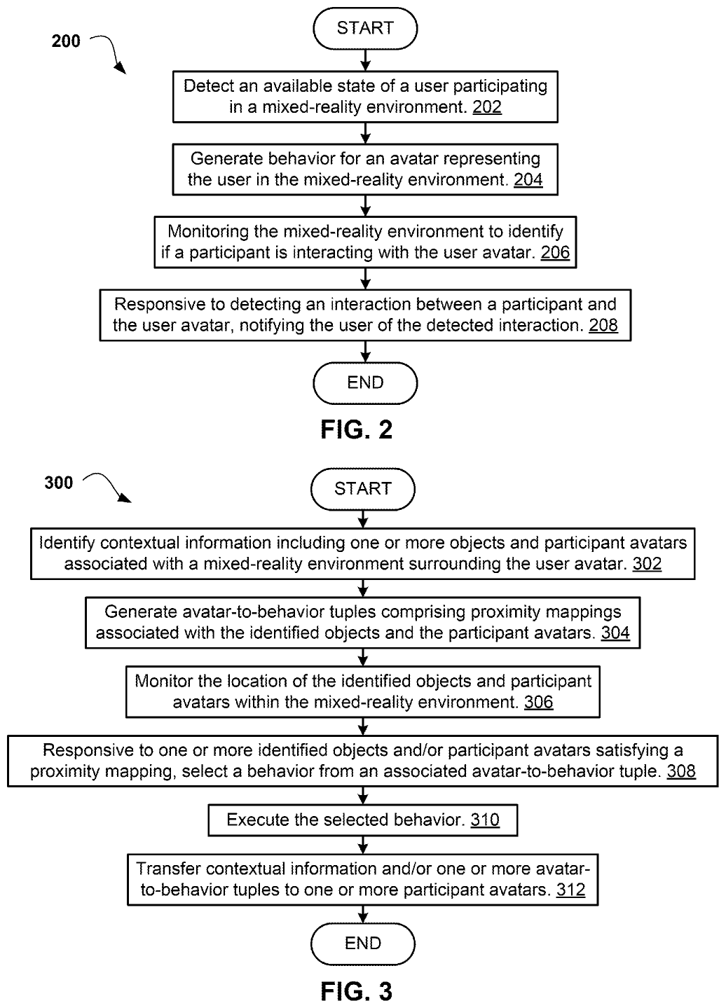

According to the present embodiment, the congruent learning program 108 may be a program enabled to detect an available state of a user, generate behavior for an avatar of the user in a mixed-reality environment, and transmit interactions or notifications of interactions to the user for the duration of the available state. The congruent learning program 108 may, when executed, cause the computing environment 100 to carry out a congruent learning process 200. The congruent learning process 200 may be explained in further detail below with respect to FIG. 2. In embodiments of the invention, the congruent learning program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, congruent learning program 108 may be distributed in its operation over any number or combination of the aforementioned devices. The congruent learning program 108 may, in embodiments, be a module or subcomponent of mixed-reality social network 107, operate as an independent application called by or in communication with mixed-reality social network 107, or otherwise interoperate with mixed-reality social network 107.

Referring now to FIG. 2, an operational flowchart illustrating a congruent learning process 200 is depicted according to at least one embodiment. At 202, the congruent learning program 108 may detect an available state of a user participating in a mixed-reality environment. A user may be participating in a mixed-reality environment when a computing device associated with the user is locally or remotely accessing the mixed-reality environment, such that the user is able to control a user avatar in the mixed-reality environment and, through the user avatar, interact with the mixed-reality environment, objects within the mixed-reality environment, and communicate with other participants represented within the mixed-reality environment by their respective avatars.

The congruent learning program 108 may here detect an available state of the user, as distinct from a passive or active state; an active state of the user may be a state where the user is actively and personally controlling the user avatar and may additionally be receiving sensory information from the mixed-reality environment. A passive state of the user may be a state where the user is participating in the mixed reality environment but is not actively and personally controlling the user avatar. An available state may be a state where the user is not actively and personally controlling the user avatar but has indicated an availability and/or a desire to be notified of interactions. In an available state, the user may be receiving complete or partial sensory input from the mixed-reality environment, such as audio and/or visual information, and/or may have access to a mobile device or any other device capable of communicating with both avatar congruent learning program 108 and the user.

The congruent learning program 108 may detect an available state of the user by monitoring positional inputs from the user's mixed-reality devices; if the positional inputs cease or remain static for a period of time greater than a threshold idle duration, the congruent learning program 108 may infer that that the user is no longer in an active state, and has entered a passive state, for example after taking off the mixed-reality headset, putting down the controllers and/or leaving range of tracking sensors. The congruent learning program 108 may also monitor positional inputs from the user's mixed-reality devices to identify anomalous input patterns that may indicate that the user is no longer properly engaging with the mixed-reality positional tracking, for example by dropping controllers and letting them hang from the user's arms by a wrist strap, lifting a headset onto the user's forehead, et cetera, thereby resulting in positional data for the user that indicates motion which does not fall within the bounds of what is possible or likely for a human body to achieve. Positional inputs may comprise any sensor measurements that indicate a position of the user and/or the position of mixed-reality devices and/or mobile devices associated with or on the person of the user, such as microlocation data, accelerometer data, gyroscope data, camera feeds wherein the user is identified using image processing techniques, motion sensors, et cetera. The congruent learning program 108 may identify anomalous input patterns where rotation or bending of joints exceeds a threshold motion value, where the threshold motion value represents the maximum likely rotation or flexion of a human body. In some embodiments, the congruent learning program 108 may additionally or alternatively analyze the motion of the user's avatar using screen or device measurement techniques, as opposed to user inputs, for example through an accessibility application programming interface (API) which allows the congruent learning program 108 to access the x, y coordinate position of the avatar at a corresponding time.

In some embodiments of the invention, the congruent learning program 108 may analyze the movement of the user's avatar to determine if the movement is deterministic or stochastic, for example by determining if the user's avatar performs the exact same motion, or motions that fall within a threshold level of similarity, multiple times in a row; if the movement is deterministic, the user may be using a automation of some sort to provide inputs to the user avatar, such as an auto-clicker or movement macro program, and the congruent learning program 108 may therefore infer that the user is not personally and controlling the user avatar and is in a passive user state.

The congruent learning program 108 may additionally monitor the user devices' connection to the mixed-reality environment and/or the mixed-reality social network 107; if the connection terminates for any reason, the user is no longer in an active, passive or available state, and congruent learning program 108 may terminate.

In some embodiments of the invention, the congruent learning program 108 may graphically represent the state of the user by adding a graphical element associated with the user avatar that represents the state of the user; the graphical element may comprise a letter or symbol hovering above the user, a colored aura emanating from the user, text appended to a username projected above the user avatar, a colored icon displayed proximate to the user avatar, et cetera. The graphical element may comprise a different color, shape, spelling, location, et cetera based on whether the user is in an active state, a passive state, or an available state. In some embodiments, the congruent learning program 108 may graphically represent that the user is in an active state even where the user is in an available state. The congruent learning program 108 may dynamically update the graphical element to reflect the changing state in real time.

Upon determining that the user is in a passive user state, the congruent learning program 108 may infer whether the user has indicated a desire to be informed of interactions between the user's avatar and any number of participants. In some embodiments, the congruent learning program 108 may consult a pre-provided entry in a database of user information that indicates whether the user desires to be notified of interactions while absent from the mixed-reality experience. If the user has indicated a desire to be notified of interactions while absent, the congruent learning program 108 may conclude that the user is in an available state.

In some embodiments of the invention, the congruent learning program 108 may additionally or alternatively determine one or more means to communicate with the user, for example by identifying devices on the person of the user and/or within earshot of the user and/or visible to the user that are capable of communicating with both the user and with congruent learning program 108. The congruent learning program 108 may identify such communication devices by, for instance, receiving positional/location/movement data from a user's mobile device or other devices, receiving positional/location/movement data from the mixed-reality devices, and/or through IoT sensors which may be capable of detecting user movement within the user's physical environment. In some embodiments, for example where the congruent learning program 108 receives both data from at least one mixed-reality device and at least one mobile device, the congruent learning program 108 may determine whether the movement data from the two devices match; if the movement data does match, the congruent learning program 108 may infer that the devices are on the person of the user. In some embodiments, the congruent learning program 108 may monitor audio inputs from the user's mixed-reality device/headset; if the audio falls within an average range of volume associated with the user, the congruent learning program 108 may infer that the mixed- reality device is on the person of the user. If the audio is attenuated such that it falls below that average range of volume, the congruent learning program 108 may infer that the mixed-reality device or headset is not on the person of the user. If the mixed-reality device or headset is moving stochastically, and/or falls within the motion threshold, the congruent learning program 108 may determine that the mixed-reality device or headset is on the person of the user. In some embodiments, the congruent learning program 108 may identify, and/or be pre-provided by the user, static devices within the physical environment of the user and which are capable of communicating with both the user and the congruent learning program 108, such as display-equipped devices such as televisions, speaker-equipped devices such as smart home assistant devices or desktop computers, et cetera. If at least one device is on the person of the user, or there is at least one static device which congruent learning program 108 can connect to or provide instructions to in order to communicate visually and/or audibly with the user, the congruent learning program 108 may determine that the user is in an available state.

At 204, the congruent learning program 108 may generate behavior for an avatar representing the user in a mixed-reality environment of the mixed-reality experience. Upon determining that the user is in an available state, the congruent learning program 108 may use a machine learning model, such as a recurrent neural network, to generate natural-appearing behaviors for the user avatar based on objects and participant, or ‘other,’ avatars in the environment, such that the avatar appears to behave as if it were still being actively controlled by a user. The congruent learning program 108 may generate behavior using the machine learning model; the machine learning model may be trained using training inputs comprising animations of an avatar and contextual information regarding the context within which the animation was performed, including the state, terrain, composition, et cetera of the mixed reality environment, the relative locations and distances of other objects, environmental features and/or avatars within the mixed-reality environment, user positional data, et cetera. The training animations may comprise movements recorded by the user, animations recorded of avatars representing other participants, animations recorded of avatars representing other participants in a similar or matching class, guild, group, et cetera or possessing similar or matching appearances, user or avatar traits, user preferences, avatar forms/physical dimensions, et cetera, or computer-generated or human-created animations that do not comprise recorded movements of an avatar. The machine learning model may be trained to output an appropriate animation based on provided contextual information. The generating step 204 may be described in greater detail below with reference to FIG. 3.

At 206, the congruent learning program 108 may monitor the mixed-reality environment to identify if a participant is interacting with the user avatar. The congruent learning program 108 may, for the entire duration that the user is in an available state, actively track, for example, the distance between the user avatar and participant avatars and virtual objects in the environment, as well as the motions of participant avatars, and/or may monitor text and audio outputs from the mixed-reality environment. If an avatar is facing the user avatar and moves in a way that congruent learning program 108 is able to match with a particular gesture, for example by matching the movement against a database comprising movements associated with common gestures, the congruent learning program 108 may identify the avatar as interacting with the user avatar. The congruent learning program 108 may also monitor the audio and text, using natural language processing techniques, for instances of the user's real name or username, or detect the receipt of audible or textual communications that are sent directly to the user or to a shared communications channel comprising the user. The congruent learning program 108 may identify the sender of such communications and may identify such communications as interactions with the user avatar. In some embodiments, the congruent learning program 108 may detect when an object or user has moved within a threshold proximity to the user avatar representing the user avatar's personal space; the congruent learning program 108 may identify the proximity of the avatar as representing an interaction between the user avatar and the participant represented by the proximate avatar, and if the object was thrown or moved by another avatar, the congruent learning program 108 may identify the proximate object as representing an interaction between the user avatar and the participant whose avatar threw or moved the object.

At 208, the congruent learning program 108 may, responsive to detecting an interaction between a participant and the user avatar, notify the user of the detected interaction. The congruent learning program 108 may identify all devices that are on the person of the user, or are within a communication distance of the user and accessible to the congruent learning program 108 such that congruent learning program 108 may be able to communicate visually and/or audibly with the user through the devices; the congruent learning program 108 may select a device from among the identified devices to use to communicate with the user. The congruent learning program 108 may select a device based on the proximity of the device to the user; devices on the person of the user may be prioritized highest. If there are two devices on the person of the user, the congruent learning program 108 may prioritize mixed-reality devices. The congruent learning program 108 may communicate with the user using supported interface methods of the selected device, including synthesized speech, notification sounds, text messages, popup windows or other graphical notifications, et cetera. In some embodiments of the invention, for example where the interaction comprises a voice call, speech detected on a voice channel in which the user is participating, et cetera, and the mixed-reality device is not on the person of the user, the congruent learning program 108 may initiate a voice call to the user's mobile device or to a static device in earshot of the user. The congruent learning program 108 may present to the user a suite of options allowing the user to control the notification process, for example by selecting interface options, providing devices for congruent learning program 108 to select from, restricting devices from selection at different times of day or under different circumstances, et cetera.

Referring now to FIG. 3, an operational flowchart 300 illustrating a generating step 204 of a congruent learning process 200 is depicted according to at least one embodiment. At 302, the congruent learning program 108 gathers contextual information including one or more objects associated with a mixed-reality environment surrounding the user avatar. The congruent learning program 108 may gather contextual information by utilizing computer vision techniques to analyze the visual output from the mixed-reality experience displayed to the user, for example using the accessibility API, and infer what objects are on screen, and/or other contextual information including information describing the mixed-reality environment. The congruent learning program 108 may extract meta information describing such objects, either from the program hosting the mixed-reality environment, such as the mixed-reality social network, through the accessibility API, or by looking up the objects in a pre-provided or otherwise accessible database. The meta information may provide description of the object. For example, the meta information for a palm tree may read “common name for a tree of the family Arecaceae,” and meta information for a boulder may read “a detached worn large rock.” In some cases, the meta information may describe an object in terms of how a user avatar may interact with the object; for example, a chair may be described as “a place to sit,” and a pineapple may be described as “something to eat,” from which the congruent learning program 108 may infer that the user avatar may be able to sit on the chair or eat the pineapple. The congruent learning program 108 may parse the descriptions to identify objects with descriptions that describe how the user avatar may interact with the object, for example by using natural language processing techniques to determine the presence of verbs in the description. The congruent learning program 108 may identify all objects with corresponding meta information that describes how the user avatar may interact with the object as ‘interactable objects.’ Referring to the previous examples, the congruent learning program 108 may therefore identify the palm tree and boulder as non-interactable objects and may identify the chair and pineapple as interactable objects. Objects so identified may be added to a learning repository with associated metadata which helps users to identify the purpose and the actions associated with the identified objects, and which may be associated with, for example, the program creating the mixed-reality experience, the class or type of mixed-reality experience, and/or the user.

At 304, the congruent learning program 108 generates avatar-to-behavior tuples comprising proximity mappings associated with the one or more identified objects and participant avatars. The congruent learning program 108 may generate one or more avatar-to-behavior tuples for the identified/inferred objects, and/or the identified interactable objects, and/or participant avatars; an avatar-to-behavior tuple may be a list of behaviors, extracted from the meta information of the one or more identified objects or from a pre-provided list or user profile associated with a participant avatar, that the user avatar may execute in connection with the identified objects or avatars. Interactable objects may be identified as having particular compatible behaviors that the user may perform, such as a chair being compatible with a sitting behavior or a tree being compatible with a climbing behavior; however, both interactable and non-interactable objects may be compatible with a number of default behaviors, which may comprise a generic behaviors which are not described in the metadata associated with the object but which may only be inferred based on the general size or shape of the object. For instance, a wall may be a non-interactable object, but due to the size and flat nature of the wall, the congruent learning program 108 may infer that a user avatar may lean against the wall; a tree may be an interactable object if it can be climbed, but the congruent learning program 108 may additionally infer that a user would be able to lean against the tree. As such, the avatar-to-behavior tuple of a tree may comprise the following: [climb, lean], and the avatar-to-behavior tuple of a wall may comprise merely [lean]. The congruent learning program 108 may generate an avatar-to-behavior tuple for non-user avatars, as well, including behaviors such as look at, turn to face, high five, wave, et cetera. Avatar-to-behavior tuples of participant avatars may be uniform or may be tailored to each participant avatar based on, for example, whether an avatar is associated with a friend of the user or belongs to a matching group, channel, friend list, clan, et cetera, such that different behaviors may be available for the user avatar to perform based on which participant avatar the user avatar is close to. For example, the user avatar may high-five proximate avatars of friends, and may merely wave at proximate avatars of non-friends. Each avatar-to-behavior tuple may be associated with a proximity mapping; the proximity mapping may be additional information tied to each behavior comprising the avatar-to-behavior tuple, which describes a minimum threshold distance from the user avatar beyond which a behavior may not be performed. For example, two avatars may need to be within a few feet of each other to perform a high-five behavior but may execute a wave behavior at a much greater distance. The minimum threshold distance for each proximity mapping may be pre-defined, or may be inferred by identifying the behaviors of the user avatar in the mixed reality environment while the user is actively engaged and recording the distance between the user avatar and the object or avatar with which the user avatar is interacting, or any other method. In some embodiments, the proximity mapping may comprise one or more additional pre-conditions that must be met before the behavior can be executed beyond relative distance, such as whether there are intervening objects, avatars, environmental features, et cetera between the user avatar and the object or participant avatar that might occlude line of sight or block movement or interaction between the user avatar and the object or participant avatar.

At 306, the congruent learning program 108 monitors the location of the identified objects and participant avatars within the mixed-reality environment. In some embodiments, the congruent learning program 108 may monitor the location of the identified objects and participant avatars by arranging the x, y location of one or more avatars within the mixed reality environment, including the user avatar and participant avatars, along with the objects in the mixed-reality environment and their associated metadata, by using arc tangent and Euclidian distance features. Recording the x, y location using arc tangent and Euclidian space allows the congruent learning program 108 to track the co-ordinates of the avatars and other objects in a two-or multi-dimensional space, as opposed to representing the distance between two points which may lead to a representation encompassing merely a one-dimensional space and thereby failing to record an exact location of the avatars and objects with respect to each other, and accordingly improving the accuracy of position tracking.

At 308, the congruent learning program 108, responsive to one or more identified objects and/or participant avatars satisfying a proximity mapping, select a behavior from an associated avatar-to-behavior tuple. As the Euclidian distance between the user avatar and an object or participant avatar grows shorter and falls within one or more minimum distance thresholds described by the proximity mappings, the congruent learning program 108 may select a behavior to execute from the avatar-to-behavior tuple associated with the approaching object or avatar. The congruent learning program 108 may select a behavior to be executed at pre-determined, random, regular, et cetera intervals, and/or responsive to one or more identified objects and/or participant avatars entering a proximity mapping of a behavior associated with such identified objects and/or participant avatars.

In embodiments, the congruent learning program 108 may select a behavior to be executed from among the behaviors with satisfied proximity mappings using Bayesian inference; Bayesian Interference may involve making statistical interferences regarding the probability of occurrence as more information becomes available. For example, where elements moving closer to the user avatar comprise four chairs and three avatars, the congruent learning program 108 might identify two possible behaviors: a) sitting on the chair and b) pick up the chair. The congruent learning program 108 may identify that the participant avatars are gathered sitting on the chairs; accordingly, the congruent learning program 108 may identify that sitting on the chairs is a more probable behavior that an avatar would be executing in this context, and may accordingly execute a behavior to sit on the empty chair rather than picking up a chair. Deriving the performed object action through Bayesian inference may allow for a white box approach of action probabilities.

At 310, the congruent learning program 108 executes the selected behavior. Responsive to congruent learning program 108 selecting a behavior, the congruent learning program 108 may execute the selected behavior by operating the user avatar to perform the animation associated with the behavior. In some embodiments, the congruent learning program 108 may modify the selected behavior and/or the generated animation prior to or during execution by linearly extrapolating based on the distance of the user avatar and the object or participant avatar associated with the selected behavior, such that the behavior is not only replicated, but replicated with the extrapolation, to take into account the distance between the user avatar and the object or participant avatar and create a natural-appearing result. For example, where a chair is outside of a proximity mapping for a “sit” action associated with a chair, congruent learning program 108 may add a “walking” behavior to navigate the user avatar to within the proximity mapping of the chair before executing the “sit” behavior. For the entire duration of time that congruent learning program 108 identifies the user as being in an available state, which may be the period of time between when congruent learning program 108 first identifies that the user has entered an active state and when congruent learning program 108 has determined that the user has either terminated the session or returned to an active state, the congruent learning program 108 may control the user's avatar to execute the generated behaviors as they are selected.

At 312, the congruent learning program 108 transfers contextual information and/or one or more avatar-to-behavior tuples to one or more participant avatars. In some embodiments, for example where congruent learning program 108 services multiple users simultaneously within the same mixed-reality environment, for instance where congruent learning program 108 comprises multiple independently operating and/or distributed instances that are in communication with each other, or comprises a single unified instance with a subprocesses for each of multiple users, congruent learning program 108 may transfer identified objects, avatars, associated avatar-to-behavior tuples, individual behaviors, and/or their associated proximity mappings to participant avatars in the mixed-reality environment; for example where such participant avatars may be too distant from an object or avatar such that they are outside the threshold distance of the associated proximity mapping for the transferred behavior. For example, in a mixed reality environment, a first avatar, second avatar, and third avatar are all in an available state, and may be disposed at various distances from a chair. Where a first avatar is too distant from a chair, such that the first avatar is outside the proximity mapping of the “sit” behavior associated with the chair, but a second and third avatar are within the proximity mapping of the “sit” behavior associated with the chair, the first avatar may transfer the “sit” behavior and its proximity mappings to the second and third avatars so that all three avatars can share the same sitting behavior, which may in turn ensure congruent, and therefore more believable, behavior. Such transferred data transmitted from one avatar to another may not comprise an identical or substantially similar copy but may rather comprise a linear extrapolation of the associated behavior to replicate the behavior from the sender avatar using the receiving avatar, taking into account the size, dimensions, features, et cetera of the receiving avatar. from the congruent learning program 108 may transfer such data based on linear algebra, object identification, meta derivation, proximity calculation and/or actions selected using Bayesian interference. The transfer itself could be sent from the account or program associated with the user avatar to the account or program associated with the individual represented by the receiving avatar, for example using an instant message protocol based on an open standard (e.g., WebRTC, Briar, etc.) using JSON formatting.

It may be appreciated that FIGS. 2-3 provides only illustrations of individual implementations and do not imply any limitations with regard to how different embodiments may be implemented.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method comprising:
detecting an available state of a user participating in a mixed-reality environment;
generating behavior for a user avatar representing the user in the mixed-reality environment;
controlling the user avatar to perform the generated behavior;
monitoring the mixed-reality environment to identify if a participant is interacting with the user avatar; and
responsive to detecting an interaction between the participant and the user avatar, notifying the user of the detected interaction.

2. The method of claim 1, wherein the available state of the user comprises a state where the user is logged into but not interacting with the mixed-reality environment, is in communication range of one or more devices, and desires to be notified of the detected interactions.

3. The method of claim 1, wherein the detecting further comprises:
identifying one or more devices on the person of the user and within communication distance of the user.

4. The method of claim 1, wherein the generating comprises the steps of:
identifying contextual information including one or more objects and one or more participant avatars associated with the mixed-reality environment;
generating avatar-to-behavior tuples comprising proximity mappings associated with the one or more identified objects and the one or more participant avatars;
monitoring a location of the identified objects and participant avatars within the mixed-reality environment;
responsive to one or more identified objects and/or one or more participant avatars satisfying at least one proximity mapping, selecting a behavior from an associated avatar-to-behavior tuple; and
executing the selected behavior.

5. The method of claim 4, wherein the generating further comprises:
transferring a plurality of contextual information and/or one or more avatar-to-behavior tuples to one or more participant avatars.

6. The method of claim 1, wherein the notifying comprises:
initiating a voice call between the user and the participant using a mobile device on the person of the user.

7. The method of claim 1, wherein the notifying comprises selecting a device of one or more devices based on a proximity to the user.

8. A computer system comprising:
one or more processors, one or more computer-readable memories and one or more computer-readable storage media;
program instructions, stored on at least one of the one or more storage media for execution by at least one of the one or more processors via at least one of the one or more memories, to detect an available state of a user participating in a mixed-reality environment;
program instructions, stored on at least one of the one or more storage media for execution by at least one of the one or more processors via at least one of the one or more memories, to generate behavior for a user avatar representing the user in the mixed-reality environment;
program instructions, stored on at least one of the one or more storage media for execution by at least one of the one or more processors via at least one of the one or more memories, to control the user avatar to perform the generated behavior;
program instructions, stored on at least one of the one or more storage media for execution by at least one of the one or more processors via at least one of the one or more memories, to monitor the mixed-reality environment to identify if a participant is interacting with the user avatar; and
program instructions, stored on at least one of the one or more storage media for execution by at least one of the one or more processors via at least one of the one or more memories, to, responsive to detecting an interaction between the participant and the user avatar, notify the user of the detected interaction.

9. The computer system of claim 8, wherein the available state of the user comprises a state where the user is logged into but not interacting with the mixed-reality environment, is in communication range of one or more devices, and desires to be notified of the detected interactions.

10. The computer system of claim 8, wherein the program instructions to detect further comprises:
program instructions, stored on at least one of the one or more storage media for execution by at least one of the one or more processors via at least one of the one or more memories, to identify one or more devices on the person of the user and within communication distance of the user.

11. The computer system of claim 8, wherein the program instruction to generate comprise:
program instructions, stored on at least one of the one or more storage media for execution by at least one of the one or more processors via at least one of the one or more memories, to identify contextual information including one or more objects and one or more participant avatars associated with the mixed-reality environment;
program instructions, stored on at least one of the one or more storage media for execution by at least one of the one or more processors via at least one of the one or more memories, to generate avatar-to-behavior tuples comprising proximity mappings associated with the one or more identified objects and the one or more participant avatars;
program instructions, stored on at least one of the one or more storage media for execution by at least one of the one or more processors via at least one of the one or more memories, to monitor a location of the identified objects and participant avatars within the mixed-reality environment;
program instructions, stored on at least one of the one or more storage media for execution by at least one of the one or more processors via at least one of the one or more memories, to, responsive to one or more identified objects and/or one or more participant avatars satisfying at least one proximity mapping, select a behavior from an associated avatar-to-behavior tuple; and
program instructions, stored on at least one of the one or more storage media for execution by at least one of the one or more processors via at least one of the one or more memories, to execute the selected behavior.

12. The computer system of claim 11, wherein the program instructions to generate further comprise:
program instructions, stored on at least one of the one or more storage media for execution by at least one of the one or more processors via at least one of the one or more memories, to transfer a plurality of contextual information and/or one or more avatar-to-behavior tuples to one or more participant avatars.

13. The computer system of claim 8, wherein the program instructions to notify further comprises:
program instructions, stored on at least one of the one or more storage media for execution by at least one of the one or more processors via at least one of the one or more memories, to initiate a voice call between the user and the participant using a mobile device on the person of the user.

14. The computer system of claim 8, wherein the program instructions to notify comprise program instructions, stored on at least one of the one or more storage media for execution by at least one of the one or more processors via at least one of the one or more memories, to select a device of one or more devices based on a proximity to the user.

15. A computer program product for adjusting an audible area of an avatar's voice, the computer program product comprising:
one or more computer-readable storage media;
program instructions, stored on at least one of the one or more storage media, to detect an available state of a user participating in a mixed-reality environment;
program instructions, stored on at least one of the one or more storage media, to generate behavior for a user avatar representing the user in the mixed-reality environment;
program instructions, stored on at least one of the one or more storage media for execution, to control the user avatar to perform the generated behavior;
program instructions, stored on at least one of the one or more storage media, to monitor the mixed-reality environment to identify if a participant is interacting with the user avatar; and
program instructions, stored on at least one of the one or more storage media, to, responsive to detecting an interaction between the participant and the user avatar, notify the user of the detected interaction.

16. The computer program product of claim 15, wherein the available state of the user comprises a state where the user is logged into but not interacting with the mixed-reality environment, is in communication range of one or more devices, and desires to be notified of the detected interactions.

17. The computer program product of claim 15, wherein the program instructions to detect further comprises:
program instructions, stored on at least one of the one or more storage media, to identify one or more devices on the person of the user and within communication distance of the user.

18. The computer program product of claim 15, wherein the program instruction to generate further comprises:
program instructions, stored on at least one of the one or more storage media, to identify contextual information including one or more objects and one or more participant avatars associated with the mixed-reality environment;
program instructions, stored on at least one of the one or more storage media, to generate avatar-to-behavior tuples comprising proximity mappings associated with the one or more identified objects and the one or more participant avatars;
program instructions, stored on at least one of the one or more storage media, to monitor a location of the identified objects and participant avatars within the mixed-reality environment;
program instructions, stored on at least one of the one or more storage media, to, responsive to one or more identified objects and/or one or more participant avatars satisfying at least one proximity mapping, select a behavior from an associated avatar-to-behavior tuple; and
program instructions, stored on at least one of the one or more storage media, to execute the selected behavior.

19. The computer program product of claim 18, wherein the program instructions to generate further comprise:
program instructions, stored on at least one of the one or more storage media, to transfer a plurality of contextual information and/or one or more avatar-to-behavior tuples to one or more participant avatars.

20. The computer program product of claim 15. wherein the program instructions to notify further comprise:
program instructions, stored on at least one of the one or more storage media, to initiate a voice call between the user and the participant using a mobile device on the person of the user.
